(19) United States
(12) Patent Application Publication
(10) Pub. No.: US 2010/0188383 A1
(43) Pub. Date: Jul. 29, 2010

(54) Display driver circuit and display apparatus using the same

(75) Inventor: Yasushi Koyata, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/656,155

(22) Filed: Jan. 19, 2010

(30) Foreign Application Priority Data
Jan. 20, 2009 (JP) 2009-010413

(51) Int. Cl. G06F 3/038

(52) U.S. Cl. 345/211

(57) ABSTRACT

A display driver circuit includes: a power supply circuit having a plurality of voltage output terminals to output a plurality of power supply voltages of different voltage levels; first and second circuit terminals; first and second lower voltage relay terminals; a logic circuit configured to generate a first control signal outputted and a second control signal; and first and second output circuits connected with the first and second lower voltage relay terminals and configured to output the first and second control signals from the first and second circuit terminals, respectively. The first and second control signals take first and second lower signal levels, respectively.

### INCORPORATION BY REFERENCE

This patent application claims a priority on convention based on Japanese Patent Application No. 2009-010413. The disclosure thereof is incorporated herein by reference.

### BACKGROUND OF THE INVENTION

1. Field of the Invention

The present invention relates to a display driver circuit and a display apparatus, and more particularly, to a display driver circuit that can switch an ON/OFF voltage level of a panel control signal and a display apparatus using the same.

2. Description of Related Art

An ON/OFF voltage level for panel control of a display apparatus changes depending on a type of a panel. Also, the ON/OFF voltage level for panel control changes depending on a type of a control signal such as a multiplexer control signal or a gate control signal. It should be noted that in an LTPS (Low Temperature Polysilicon) panel, a multiplexer circuit and a gate circuit can be mounted on glass. Also, in the LTPS panel, COG (Chip on Glass) interconnection is possible. Further, a display driver IC circuit can be mounted with a power supply circuit that outputs voltages of a plurality of different voltage levels.

Referring to FIG. 1, a configuration of a conventional display apparatus using a conventional display driver circuit will be described. The conventional display apparatus 101 includes an X driver circuit 110, a Y driver circuit 120, a liquid crystal panel 210, an X side power supply circuit 310, a Y side power supply circuit 320, and a driver control circuit 410.

Power supply voltages of voltage levels for the X and Y driver circuits are supplied from the power supply circuits. That is, the voltages of voltage levels (VHX, VCX, and VLX) for the X driver circuit 110 are supplied from the X side power supply circuit 310, and the voltages of voltage levels (VHY, VCY, and VLY) for the Y driver circuit 120 are supplied from the Y side power supply circuit 320.

Referring to FIGS. 2A and 2B, configurations of the conventional display apparatus will be described. A display driver circuit 102 includes multiplexer control terminals 11, gate control terminals 21, a power supply circuit 31, and a logic circuit (LOGIC) 41. The multiplexer control terminal 11 outputs a multiplexer control signal. The gate control terminal 21 outputs a gate control signal. The power supply circuit 31 outputs voltages of a plurality of different voltage levels. The logic circuit 41 controls the multiplexer control signal, the gate control signal, and the power supply circuit 31.

Also, in a panel type A shown in FIG. 2A, the display driver circuit 102 is provided with power supply output terminals VGH and VGL, and a ground terminal VSS. In a panel type B shown in FIG. 2B, the display driver 102 is provided with the power supply terminals VGH and VPL, and the ground terminal VSS. The power supply output terminals VGH, VGL, and VPL are connected to the power supply circuits 30 and outputs voltages of different voltage levels. In this conventional examples, in the panel type A, voltages of voltage levels (VGH=10 V, and VGL=−5 V) are outputted. In the panel type B, voltages of voltage levels (VGH=10 V, and VPL=−1.5 V) are outputted. The ground terminal VSS is a ground (GND) terminal that is grounded, and outputs a voltage of a predetermined voltage level (VSS=0 V).

In the panel type A, ON levels of the multiplex control signal and the gate control signal are connected to the power supply output terminal VGH, and OFF levels of them are respectively connected to the power supply output terminal VGL and the ground terminal VSS in the driver circuit. Thus, the multiplex and gate control signals swing between 15 V and 10 V. In the conventional example, the ON level of multiplexer control terminal 10=the ON level of gate control terminal 20=VGH (10 V). Also, the OFF level of multiplexer control terminal 10=VGL (−5 V), and the OFF level of gate control terminal 20=VSS (0 V).

In the panel type B, the ON levels of the multiplex control signal and the gate control signal are connected to the power supply output terminal. VGH, and the OFF levels of them are connected to VPL in the driver circuit, and the multiplex and gate control signals swing between 10 V and −1.5 V. In the convention example, the ON level of multiplexer control terminal 10=the ON level of gate control terminal 20=VGH (10 V). Also, the OFF level of multiplexer control terminal 10=the OFF level of gate control terminal 20=VPL (−1.5 V).

In conjunction with the above description, a related technique is shown in Japanese Patent Publication (JP 2000-147455A) which discloses a driving device for a liquid crystal panel and a liquid crystal apparatus. In this related technique, a Y driver circuit and an X driver circuit supply voltages of effective values corresponding to a gray-scale level shown by gray-scale data to the liquid crystal panel. Also, a driver control circuit switches effective values of voltages for respective gray-scale levels in the X driver circuit to setting values for a reflection type display in accordance with the non-lighting of a light source, and to the setting values for a transmission type display in accordance with the lighting of the light source.

In the configuration of FIG. 1, all output terminals of the Y driver circuit takes same voltages. That is, voltage levels of all the output terminals of the Y driver circuit are same. A plurality of panel control signals of different ON/OFF levels cannot be controlled with the single display driver circuit. In the case where the ON/OFF levels change depending on a type of a signal or a panel, a display driver circuit dedicated to each panel is required.

In the configuration of FIG. 2, the OFF voltage levels of the multiplexer control signal and the gate control signal cannot be changed. In the case of controlling the panel types A and B respectively having the different OFF levels, a display driver circuit dedicated to each of the panels is required.

### SUMMARY OF THE INVENTION

In an aspect of the present invention, a display driver circuit includes: a power supply circuit having a plurality of voltage output terminals to output a plurality of power supply voltages of different voltage levels; first and second circuit terminals; first and second lower voltage relay terminals; a logic circuit configured to generate a first control signal outputted and a second control signal; and first and second output circuits connected with the first and second lower voltage relay terminals and configured to output the first and second control signals from the first and second circuit terminals, respectively. The first and second control signals take first and second lower signal levels, respectively.

By changing connection points of external wiring lines, i.e., by changing a power supply output terminal depending on a type of a panel control signal, an ON/OFF voltage level of the panel control signal can be selected.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a diagram illustrating a configuration of a conventional display apparatus using a display driver circuit;

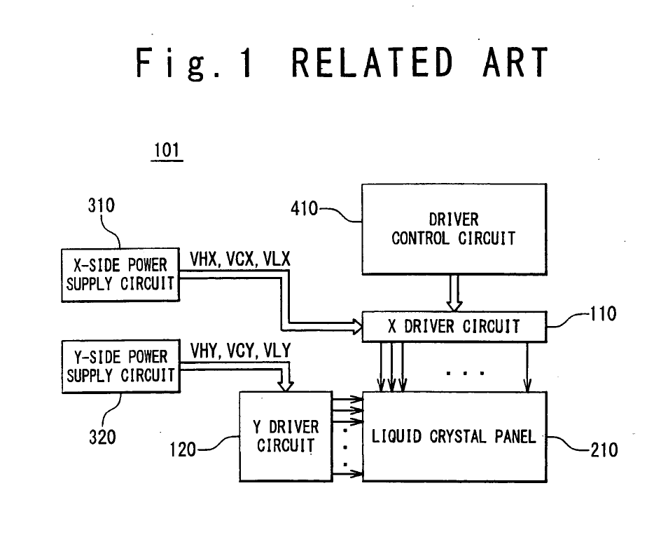

FIGS. 2A and 2B are block diagrams illustrating configurations of the conventional display driver circuits;

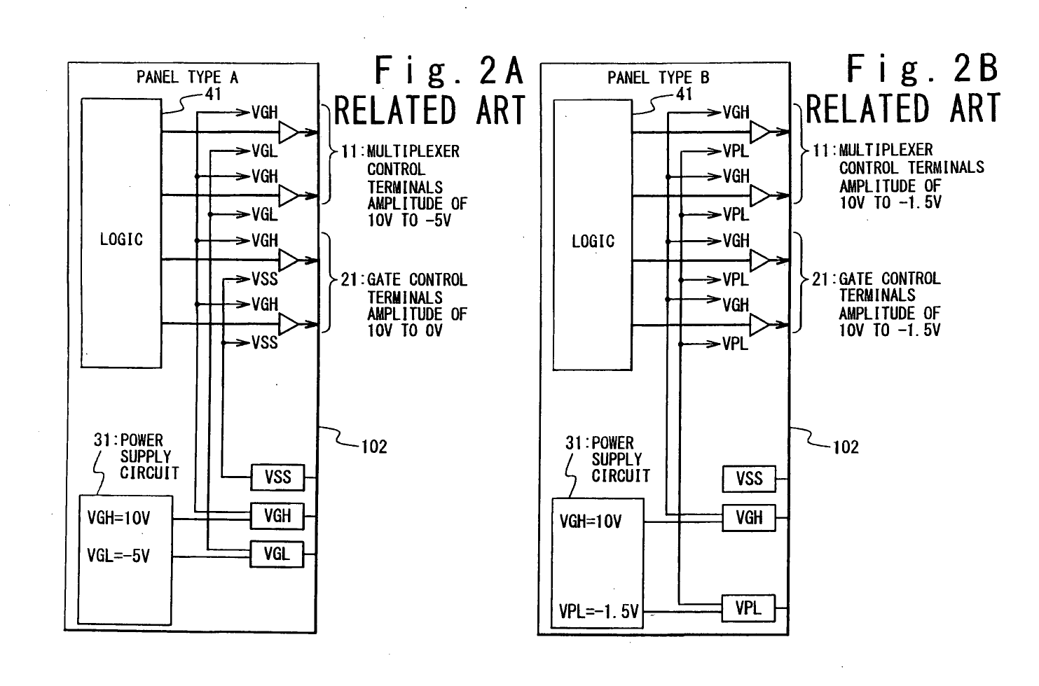

FIGS. 3A and 3B are block diagrams illustrating a configuration of a display driver circuit according to a first embodiment of the present invention in different connection methods;

FIGS. 4A and 4B are block diagrams illustrating a configuration of a display driver circuit according to a second embodiment of the present invention in different connection methods;

FIG. 5 is a table illustrating control modes performable in the second embodiment of the present invention; and

FIG. 6 is a diagram illustrating a configuration of a display driver circuit according to a third embodiment of the present invention.

### DESCRIPTION OF THE EMBODIMENTS

Hereinafter, a display apparatus using a display driver circuit of the present invention will be described in detail with reference to the attached drawings.

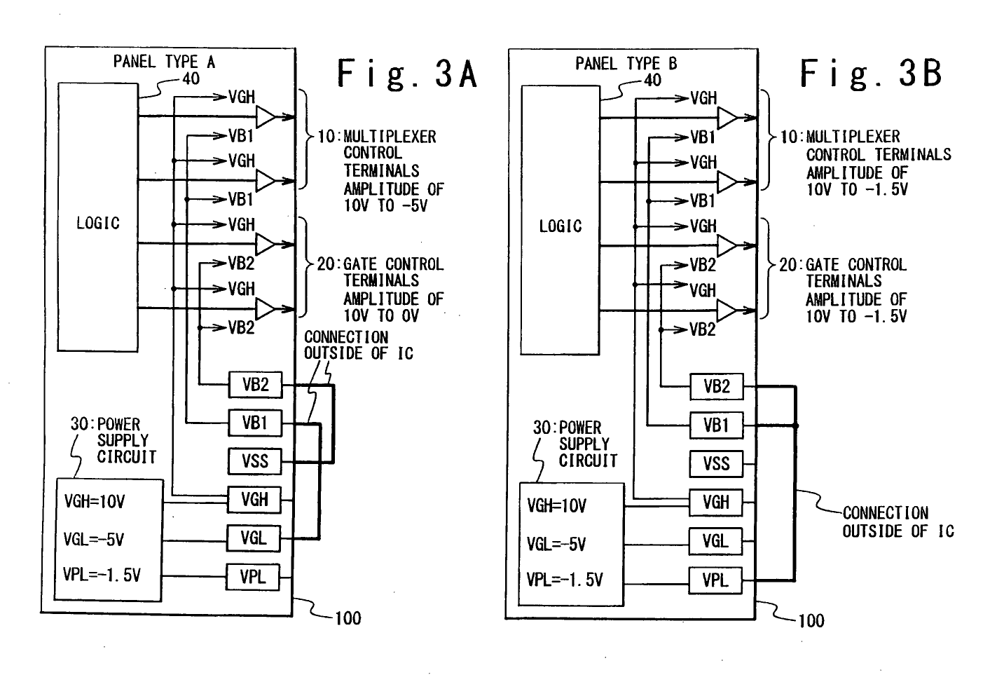

Referring to FIGS. 3A and 3B, a display driver circuit 100 according to a first embodiment of the present invention includes multiplexer control terminals 10, gate control terminals 20, a power supply circuit 30, a logic circuit (LOGIC) 40, and output circuits.

The display driver circuit 100 is a driver circuit that writes image data into a liquid crystal panel. It should be noted that the display driver circuit 100 is mounted on a display apparatus such as a liquid crystal panel. Accordingly, the display driver circuit 100 can also be read as the display apparatus.

One of the output circuits includes circuits such as buffers and outputs multiplexer control signals to the terminals 10. Another of the output circuits includes circuits such as buffers and outputs gate control signals to the terminals 20. Thus, the multiplexer control signal is outputted from the multiplexer control terminal 10, and the gate control signal is outputted from the gate control terminal 20. The power supply circuit 30 outputs power supply voltages of a plurality of different voltage levels. The logic circuit 40 controls the multiplexer control signal, the gate control signal, and the power supply circuit 30.

Also, the display driver circuit 100 is provided with power supply output terminals VGH, VGL, and VPL, a ground terminal VSS, and external terminals VB1 and VB2. The power supply output terminals VGH, VGL, VPL and VSS are connected to the power supply circuit 30, and voltages of different voltage levels (VGH=10 V, VGL=−5 V, VPL=−1.5 V, and VSS=0 V) are outputted from them. In the present embodiment, the power supply circuit 30 has the power supply output terminals VGH, VGL, VPL, and the ground terminal VSS that is grounded, and a voltage having a predetermined voltage level (VSS=0 V) is outputted from it.

The ON level of the multiplexer control signal and the gate control signal are both supplied from the power supply output terminal VGH. Accordingly, the ON level of multiplexer control terminal 10=the ON level of gate control terminal 20=VGH (10 V). The OFF level of the multiplexer control signal is supplied from the external terminal VB1, and the OFF level of the gate control signal is supplied from the external terminal VB2.

In a panel type A shown in FIG. 3A, the OFF level (VB1) of a buffer for the multiplexer control terminal 10 is connected to the power supply output terminal VGL through an external wiring line, and the OFF level (VB2) of a buffer for the gate control terminal 20 is connected to the ground terminal VSS through an external wiring line. That is, the external terminal VB1 is connected to the power supply output terminal VGL through the external wiring line, and the external terminal VB2 is connected to the ground terminal VSS through the external wiring line. Accordingly, the OFF level (VB1) of the buffer for the multiplexer control terminal 10=VGL (−5 V), and the OFF level (VB2) of the buffer for the gate control terminal 20=VSS (0 V). It should be noted that the external wiring means wiring between terminals in the outside of the driver circuit.

In a panel type B shown in FIG. 3B, the OFF level (VB1) of a buffer for the multiplexer control terminal 10, and the OFF level (VB2) of a buffer for the gate control terminal 20 are both connected to the power supply output terminal VPL through an external wiring line. That is, the external terminals VB1 and VB2 are both connected to the power supply output terminal VPL through the external wiring line. Accordingly, the OFF level (VB1) of the buffer for the multiplexer control terminal 10=the OFF level (VB2) of gate control terminal 20=VPL (−1.5 V).

Next, an operation of the first embodiment of the present invention shown in FIGS. 3A and 3B will be described. In the panel type A, the ON and OFF levels at the multiplexer control terminal 10 are respectively VGH (10 V) and VGL (−5 V), and therefore the signal swings between 10 V and −5 V. The ON level at the gate control terminal 20 and the OFF level at the gate control terminal 20 are respectively VGH (10 V) and VSS (0 V), and therefore the signal swings between 10 V and 0 V.

On the other hand, in the panel type B, the ON and OFF levels at the multiplexer control terminal 10 are respectively VGH (10 V) and VGL (−1.5 V), and therefore the signal swings between 10 V and −1.5 V. The On and OFF levels at the gate control terminal 20 are respectively VGH (10 V) and VGL (−1.5 V), and therefore the signal swings between 10 V and −1.5 V.

In each of the panel types A and B, the display driver circuit 100 can change a combination of the ON/OFF levels at the multiplexer control terminal 10 and the gate control terminals 20 only by changing the external wiring lines. That is, without preparing dedicated display driver circuits, e.g., the display drivers respectively dedicated to the panel types A and B, the single display driver circuit can be applied to the panel types A and B.

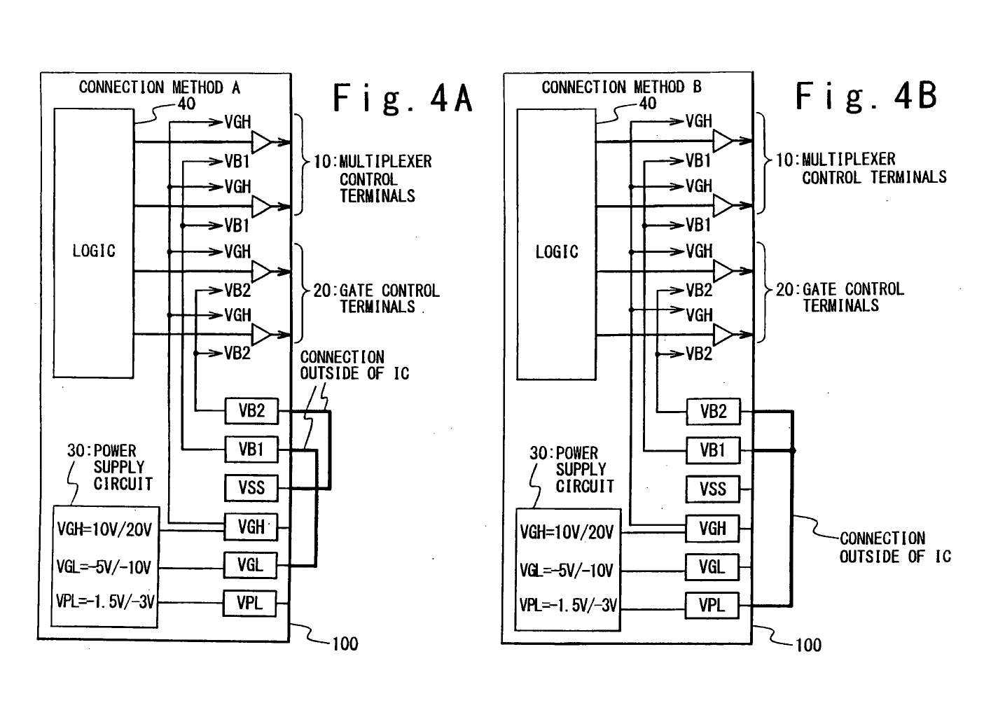

Next, a second embodiment of the present invention will be described. Referring to FIGS. 4A and 4B, the display driver circuit 100 in the present embodiment includes the multiplexer control terminals 10, the gate control terminals 20, the power supply circuit 30, the logic circuit (LOGIC) 40 and output circuits. The output circuits are similar in the first embodiment. The multiplexer control terminal 10 outputs a multiplexer control signal, and the gate control terminal 20 outputs a gate control signal. The power supply circuit 30 outputs voltages of a plurality of different voltage levels. The logic circuit 40 controls the multiplexer control signal, the gate control signal, and the power supply circuit 30.

In the present embodiment, the power supply circuit 40 can change the output voltage levels by settings. In the present embodiment, an output voltage level VGH can be switched between 10 V and 20 V. Also, an output voltage level VGL can be switched between −5 V and −10 V. Further, an output voltage level VPL can be switched between −1.5 V or −3 V.

Also, the display driver circuit 100 is provided with the power supply output terminals VGH, VGL, and VPL, the ground terminal VSS, and the external terminals VB1 and VB2. The power supply output terminals. VGH, VGL, and VPL are connected to the power supply circuit 30, and output voltages having different voltage levels (VGH=10 V/20 V, VGL=−5 V/−10 V, and VPL=−1.5 V/−3 V). In the present embodiment, the power supply circuit 30 has the power supply output terminals VGH, VGL, VPL, and the ground terminal VSS that is grounded, and outputs a voltage having a predetermined voltage level (VSS=0 V).

The ON level voltages of the multiplexer control signal and gate control signal are both supplied from the power supply output terminal VGH. Accordingly, the ON level of multiplexer control terminal 10=the ON level of gate control terminal 20=VGH (10 V/20 V). The OFF level voltage of the multiplexer control signal is supplied from the external terminal VB1, and the OFF level voltage of the gate control signal is supplied from the external terminal VB2.

In a connection method A shown in FIG. 4A, the OFF level (VB1) of the multiplexer control terminal 10 is connected to the power supply output terminal VGL through an external wiring line, and the OFF level (VB2) of the gate control terminal 20 is connected to the ground terminal VSS through an external wiring line. That is, the external terminal VB1 is connected to the power supply output terminal VGL through the external wiring line, and the external terminal VB2 is connected to the ground terminal VSS through the external wiring line. Accordingly, the OFF level (VB1) of multiplexer control terminal 10=VGL (−5 V/−10 V), and the OFF level (VB2) of gate control terminal 20=VSS (0 V).

In a connection method B shown in FIG. 4B, the OFF level (VB1) of the multiplexer control terminal 10 and the OFF level (VB2) of the gate control terminal 20 are both connected to the power supply output terminal VPL through an external wiring line. That is, the external terminals VB1 and VB2 are both connected to the power supply output terminal VPL through the external wiring line. Accordingly, the OFF level (VB1) of multiplexer control terminal 10=the OFF level (VB2) of gate control terminal 20=VPL (−1.5 V).

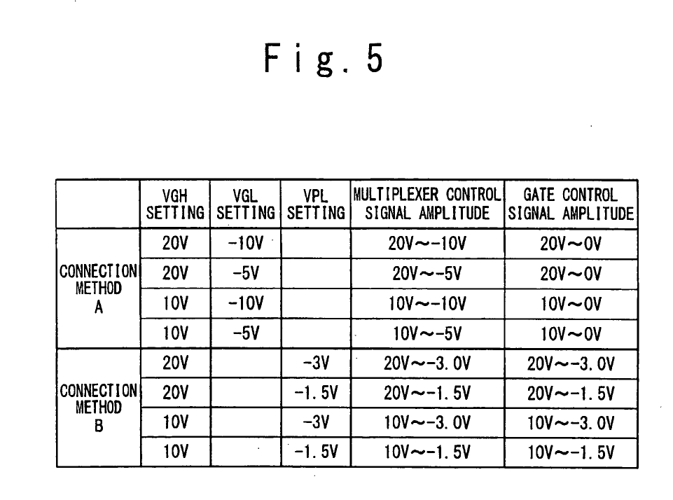

Referring to FIGS. 4A, 4B and 5, a control method performable in the present embodiment will be described. In the power supply circuit 30, the output voltage levels VGH, VGL, and VPL can be set to 20 V or 10 V, −10 V or −5 V, and −3 V or −1.5 V, respectively.

When the power supply voltage settings are changed in each of the connection methods A and B, panel control can be performed in eight different manners as illustrated in FIG. 5. In FIG. 5, the voltage settings for “VGH setting”, “VGL setting”, “VPL setting”, “Multiplexer control signal amplitude voltage”, and “Gate control signal amplitude voltage” are illustrated for each of the connection methods A and B. In this case, the panel control can be performed in the following eight different modes (1) to (8). Each of the power supply voltage settings may be performed by controlling the power supply circuit 30 based on a control data externally supplied to the logic circuit 40, or other means.

Regarding the connection method A, the following four different types of panel control can be performed. It should be noted that in the connection method A, it is not necessary to take into account a voltage setting for the “VPL setting”, and therefore entries for it are blank.

(1) In the “VGH setting” of 20 V and the “VGL setting” of −10 V, the “Multiplexer control signal amplitude voltage” is 20 V to −10 V, and the “Gate control signal amplitude voltage” is 20 V to 0 V.

(2) In the “VGH setting” of 20 V and the “VGL setting” of −5 V, the “Multiplexer control signal amplitude voltage” is 20 V to −5 V, and the “Gate control signal amplitude voltage” is 20 V to 0 V.

(3) In the “VGH setting” of 10 V and the “VGL setting” of −10 V, the “Multiplexer control signal amplitude voltage” is 10 V to −10 V, and the “Gate control signal amplitude voltage” is 10 V to 0 V.

(4) In the “VGH setting” of 10 V and the “VGL setting” of −5 V, the “Multiplexer control signal amplitude voltage” is 10 V to −5 V, and the “Gate control signal amplitude voltage” is 10 V to 0 V.

Regarding the connection method B, the following four different types of panel control can be performed. It should be noted that in the connection method B, it is not necessary to take into account a voltage setting for the “VGL setting”, and therefore entries for it are blank.

(5) In the “VGH setting” of 20 V and the “VPL setting” of −3 V, the “Multiplexer control signal amplitude voltage” is 20 V to −3.0 V, and the “Gate control signal amplitude voltage” is 20 V to −3.0 V.

(6) In the “VGH setting” of 20 V and the “VPL setting” of −1.5 V, the “Multiplexer control signal amplitude voltage” is 20 V to −1.5 V, and the “Gate control signal amplitude voltage” is 20 V to −1.5 V.

(7) In the “VGH setting” of 10 V and the “VPL setting” of −3 V, the “Multiplexer control signal amplitude voltage” is 10 V to −3.0 V, and the “Gate control signal amplitude voltage” is 10 V to −3.0 V.

(8) In the “VGH setting” of 10 V and the “VPL setting” of −1.5 V, the “Multiplexer control signal amplitude voltage” is 10 V to −1.5 V, and the “Gate control signal amplitude voltage” is 10 V to −1.5 V.

As described, in the display driver circuit 100 of the present embodiment, the combination of the ON/OFF levels at the multiplexer control terminal 10 and the gate control terminal 20 can be change or switched to any of the eight combinations only by changing the external wiring lines and power supply voltage settings. That is, without preparing driver circuits dedicated to the respective panel types, the eight different types of panel control can be performed by using the single display driver circuit. That is, by changing the external wiring lines and combining the power supply output settings, the combination of the ON/OFF levels at the multiplexer and gate control terminals 10 and 20 can be individually changed, and therefore the number of controllable panel types can be increased.

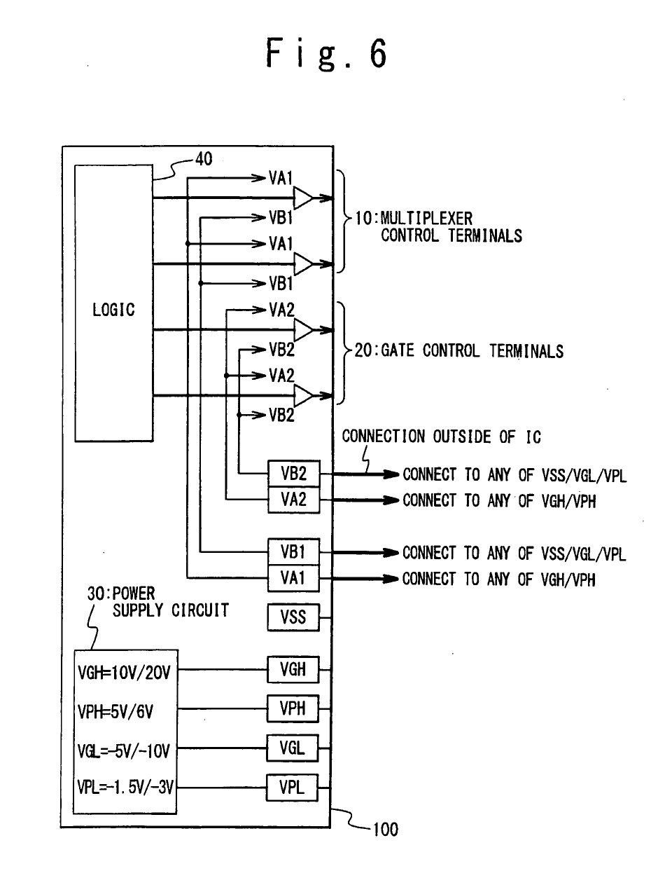

Next, a third embodiment of the present invention will be described. Referring to FIG. 6, a display driver circuit 100 in the present embodiment includes the multiplexer control terminals 10, the gate control terminals 20, the power supply circuit 30, and the logic circuit (LOGIC) 40. A multiplexer control signal is outputted from the multiplexer control terminal 10, and a gate control signal is outputted from the gate control terminal 20. The power supply circuit 30 outputs voltages of a plurality of different voltage levels. The logic circuit 40 controls the multiplexer control signal, the gate control signal, and the power supply circuit 30. In the present embodiment, the power supply circuit 30 includes VPH, in addition to the VGH, as an ON level voltage.

Also, similarly to the second embodiment, the power supply circuit 30 can switch output voltage levels by settings. In the present embodiment, the output voltage level VGH is changed to 10 V or 20 V. Also, the output voltage level VPH is changed to 5 V or 6 V. Further, the output voltage level VGL is changed to −5 V or −10 V. Still further, the output voltage level VPL is changed to −1.5 V or −3 V.

Also, the display driver circuit 100 is provided with the power supply output terminals VGH, VPH, VGL, and VPL, the ground terminal VSS, and the external terminals VA1, VB1, VA2, and VB2.

The power supply output terminals VGH, VPH, VGL, and VPL are connected to the power supply circuit 30, and output voltages of different voltage levels (VGH=10 V/20 V, VPH=5 V/6 V, VGL=−5 V/−10 V, and VPL=−1.5 V/−3 V). In the present embodiment, the power supply circuit 30 has the power supply output terminals VGH, VPH, VGL, and VPL. The ground terminal VSS is a ground (GND) terminal that is grounded, and outputs a voltage having a predetermined voltage level (VSS=0 V).

The ON level voltage of the multiplexer control signal is supplied from the external terminal VA1. The OFF level voltage of the multiplexer control signal is supplied from the external terminal VB1. The ON level voltage of the gate control signal is supplied from the external terminal VA2. The OFF level voltage of the gate control signal is supplied from the external terminal VB2.

The ON level (VA1) at the multiplexer control terminal 10 is connected to any of the power supply output terminals VGH and VPH through an external wiring line. That is, the external terminal VA1 is connected to any of the power supply output terminals VGH and VPH through the external wiring line. Accordingly, the ON level (VA1) at multiplexer control terminal 10=VGH/VPH (20 V/10 V/6 V/5 V).

The OFF level (VB1) at the multiplexer control terminal 10 is connected to any of the ground terminal VSS, and the power supply output terminals VGL and VPL through an external wiring line. That is, the external terminal VB1 is connected to any of the ground terminal VSS, and power supply output terminals VGL and VPL through the external wiring line. Accordingly, the OFF level (VB1) at multiplexer control terminal 10=VSS/VPL/VGL (0 V/−1.5 V/−3 V/−5 V/−10 V).

The ON level (VA2) at the gate control terminal 20 is connected to any of the power supply output terminals VGH and VPH through an external wiring line. That is, the external terminal VA2 is connected to any of the power supply output terminals VGH and VPH through the external wiring line. Accordingly, the ON level (VA2) at gate control terminal 20=VGH/VPH (20 V/10 V/6 V/5 V).

The OFF level (VB2) at the gate control terminal 20 is connected to any of the ground terminal VSS, and the power supply output terminals VGL and VPL through an external wiring line. That is, the external terminal VB2 is connected to any of the ground terminal VSS, and the power supply output terminals VGL and VPL through the external wiring line. Accordingly, the OFF level (VB2) at the gate control terminal 20=VSS/VPL/VGL (0 V/−1.5 V/−3 V/−5 V/−10 V).

As described, in the present embodiment, the output voltage levels VGH, VPH, VGL, and VPL can be respectively set to 20 V or 10 V, 6 V or 5 V, −10 V or −5 V, and −3 V or −1.5 V in the power supply circuit 30.

With respect to the ON levels of the multiplexer control signal and the gate control signal, the ON levels of the multiplexer control signal and the gate control signal can also be set to different voltages by respectively supplying the voltages from the external terminals VA1 and VA2.

Based on a combination of voltage settings of VGH, VPH, VGL, and VPL and connection of external wiring lines for VA1, VA2, VB1, and VB2, the number of controllable panel types can be further increased as compared with that in the second embodiment.

According to the present invention, control of a plurality of types of panels having different ON/OFF levels can be achieved by a single display driver circuit.

It should be noted that the external wiring lines in the display apparatus using the display driver circuit of the present invention may be wired to make connections between the terminals outside the circuit by a manufacturer that manufactures the display driver circuit and the display apparatus. Also, a manufacturing apparatus may be installed such that the power supply output terminals, the external terminal, and the ground terminal can be wired outside the driver circuit.

As described above, in the present invention, the display driver circuit includes the panel control terminal and the power supply for the panel ON/OFF levels, and the logic circuit controlling them. On the basis of the external wiring lines outside the display driver circuit, and the changeable combination of voltage settings of the power supply for the ON/OFF levels, the ON/OFF levels of the panel control terminals can be changed so that control of plurality of types of panels is achieved by the single display driver circuit.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A display driver circuit comprising:
a power supply circuit having a plurality of voltage output terminals to output a plurality of power supply voltages of different voltage levels;
first and second circuit terminals;
first and second lower voltage relay terminals;
a logic circuit configured to generate a first control signal outputted and a second control signal; and
first and second output circuits connected with said first and second lower voltage relay terminals and configured to output said first and second control signals from said first and second circuit terminals, respectively,
wherein said first and second control signals take first and second lower signal levels, respectively.

2. The display driver circuit according to claim 1, wherein said first and second lower signal levels are different from each other,
a first lower voltage as a specified one of said plurality of power supply voltages is supplied to said first output circuit by a first external wiring line connecting a first lower voltage output terminal as one of said plurality of voltage output terminals and said first lower voltage relay terminal, and
a second lower voltage as a specified another of said plurality of power supply voltages is supplied to said second output circuit by a second external wiring line connecting a second lower voltage output terminal as another of said plurality of voltage output terminals and said second lower voltage relay terminal.

3. The display driver circuit according to claim 1, wherein said first and second lower signal levels are equal to each other,
a third lower voltage as a specified one of said plurality of power supply voltages is supplied to said first output circuit by a first external wiring line connecting a third lower voltage output terminal as one of said plurality of voltage output terminals and said first lower voltage relay terminal, and
said third lower voltage is supplied to said second output circuit by a second external wiring line connecting said third lower voltage output terminal and said second lower voltage relay terminal.

4. The display driver circuit according to claim 1, wherein said plurality of voltage output terminals includes a first higher voltage output terminal for a first higher voltage,
the first higher voltage is supplied to said first and second output circuits by an interconnection line inside of said driver circuit connecting said first higher voltage output terminal and said first and second output circuits.

5. The display driver circuit according to claim 1, wherein said power supply circuit outputs one of two or more of said plurality of power supply voltages to each of said plurality of voltage output terminals based on a setting.

6. The display driver circuit according to claim 5, further comprising:
first and second higher voltage relay terminals connected with said first and second output circuits, respectively,
wherein said plurality of voltage output terminals includes a first higher voltage output terminal for a first higher voltage and a second higher voltage output terminal for a second higher voltage,
wherein each of said first higher voltage output terminal and said second higher voltage output terminal is connected with one of said first and second higher voltage relay terminals.

7. A display apparatus comprising:
a power supply circuit having a plurality of voltage output terminals to output a plurality of power supply voltages of different voltage levels;
first and second circuit terminals;
first and second lower voltage relay terminals;
a logic circuit configured to generate a first control signal outputted and a second control signal; and
first and second output circuits connected with said first and second lower voltage relay terminals and configured to output said first and second control signals from said first and second circuit terminals, respectively,
wherein said first and second control signals take first and second lower signal levels, respectively.

8. The display apparatus according to claim 7, wherein said first and second lower signal levels are different from each other,
a first lower voltage as a specified one of said plurality of power supply voltages is supplied to said first output circuit by a first external wiring line connecting a first lower voltage output terminal as one of said plurality of voltage output terminals and said first lower voltage relay terminal, and
a second lower voltage as a specified another of said plurality of power supply voltages is supplied to said second output circuit by a second external wiring line connecting a second lower voltage output terminal as another of said plurality of voltage output terminals and said second lower voltage relay terminal.

9. The display apparatus according to claim 7, wherein said first and second lower signal levels are equal to each other,
a third lower voltage as a specified one of said plurality of power supply voltages is supplied to said first output circuit by a first external wiring line connecting a third lower voltage output terminal as one of said plurality of voltage output terminals and said first lower voltage relay terminal, and
said third lower voltage is supplied to said second output circuit by a second external wiring line connecting said third lower voltage output terminal and said second lower voltage relay terminal.

10. The display apparatus according to claim 7, wherein said plurality of voltage output terminals includes a first higher voltage output terminal for a first higher voltage,
the first higher voltage is supplied to said first and second output circuits by an interconnection line inside of said driver circuit connecting said first higher voltage output terminal and said first and second output circuits.

11. The display apparatus according to claim 7, wherein said power supply circuit outputs one of two or more of said plurality of power supply voltages to each of said plurality of voltage output terminals based on a setting.

12. The display apparatus according to claim 11, further comprising:
first and second higher voltage relay terminals connected with said first and second output circuits, respectively,
wherein said plurality of voltage output terminals includes a first higher voltage output terminal for a first higher voltage and a second higher voltage output terminal for a second higher voltage,
wherein each of said first higher voltage output terminal and said second higher voltage output terminal is connected with one of said first and second higher voltage relay terminals.
